(19) United States
(12) Patent Application Publication
(10) Pub. No.: US 2025/0348706 A1
(43) Pub. Date: Nov. 13, 2025

(54) SYSTEM AND METHOD USING SHEAF NEURAL NETWORKS FOR MONITORING NETWORK EFFECT PROPAGATION

(71) Applicant: HSBC GROUP MANAGEMENT SERVICES LIMITED, London (GB)

(72) Inventors: Georgios KORPAS, Signapore (SG); Bing ZHU, Shanghai (CN); Jeremy KULCSAR, Hong Kong (CN); William SHOOSMITH, London (GB)

(21) Appl. No.: 19/278,737

(22) Filed: Jul. 23, 2025

(30) Foreign Application Priority Data
Mar. 24, 2025 (GR) 20250100214

(51) Int. Cl. G06N 3/042; G06N 3/0464; G06N 3/0475

(52) U.S. Cl. CPC G06N 3/042; G06N 3/0464; G06N 3/0475

(57) ABSTRACT

Systems and methods are proposed herein that instantiate and populate a graph network data structure with cross dependencies and connections that utilizes sheaf neural networks to analyze and predict the propagation of a network effect. Sheaf neural network architectures are used to simulate the propagation of signals across relational pathways encoded in the cellular sheaf representation data structure. A sheaf convolutional neural network (ShCNN) architecture is proposed that uses a constructed sheaf Laplacian operator for use in modelling diffusion dynamics in a sheaf diffusion layer that is used in concert with a sheaf convolutional layer that operates on a diffused vector, propagating and updating signals based on diffusion dynamics encoded in the sheaf Laplacian.

### CROSS-REFERENCE TO RELATED APPLICATION

The present application claims priority to Greek Patent Application No. 2025/0100214, filed on Mar. 24, 2025 and entitled System and Method using Sheaf Neural Networks for Monitoring Network Effect Propagation, the entire disclosure of which is hereby incorporated by reference in its entirety.

### FIELD

The present application relates to the field of computer architecture and more specifically, embodiments relate to computing systems and methods using sheaf neural networks for monitoring network effect propagation across interconnected data object representations. The present application also relates to the field of risk management in financial institutions, specifically the analysis and prediction of risk-contagion propagation through large and complicated networks of interconnected entities.

### INTRODUCTION

Network effects may propagate across a network where nodes are interconnected with one another. An example type of propagation of network effects may include contagion modelling, where it is possible that direct and indirect linkages may probabilistically spread the contagion from one node to another.

However, the interconnections are not always readily apparent, and thus modelling phenomena as a computer representation for analysis may be difficult. Furthermore, the computing problem complexity scales up significantly as the number of relationships and dependencies between the entity's scales, and these scaling effects compound the difficulty of the problem. These types of network effects are useful to model and analyse and have applications across applied use cases.

Traditional risk models in financial institutions often rely on simplified graph representations, capturing only pairwise relationships between entities. However, in large and complex financial institutions, risk may propagate through various paths involving multi-dimensional and asymmetrical relationships. In applications involving directional cash flows, hierarchical structures, and regulatory dependencies, traditional risk models may fall short.

### SUMMARY

Systems and methods are proposed herein that instantiate and populate a graph network data structure with cross dependencies and connections that utilize sheaf neural networks to analyze and predict the propagation of a network effect. A dataset representative of network object characteristics is received for populating and constructing a cellular sheaf representation stored as a data structure, where each entity in the network is represented by a stalk, and multi-dimensional relationships between entities are encoded in restriction maps and coboundary operators on a sheaf. Once the data structure is instantiated, sheaf neural network architectures are used to simulate the propagation of signals across relational pathways encoded in the cellular sheaf representation data structure.

A sheaf convolutional neural network (ShCNN) architecture uses a constructed sheaf Laplacian operator for use in modelling diffusion dynamics in a sheaf diffusion layer that is used in concert with a sheaf convolutional layer that operates on a diffused vector, propagating and updating signals based on diffusion dynamics encoded in the sheaf Laplacian. This type of computing representation is conducted to provide a useful mechanism for computing that captures relational relationships, including directional dependencies, signed relationships, and hierarchical structures. The ShCNN architectures are used to propagate signals across the pathways (from stalk to stalk) encoded in the sheaf structure. The ShCNN architectures have learnable parameters, such as weights, where the sheaf convolution is a learnable linear combination.

Once the ShCNN architectures are trained, they may be used for generating log it outputs based on an input for controlling downstream computing, such as automatically invoking subroutines based on identified triggers, generating table data outputs that may be used for report or visualization generation for rendering visual interface elements on a graphical user interface, among others.

While not specifically limited to the banking sector and financial institutions, as a practical example, the approach may utilize the relational structure of sheaf neural networks to model the relationships and dependencies between various entities, such as customers, accounts, and subsidiaries within a financial institution. By incorporating and encoding the multi-dimensional and asymmetric relationships between the entities into the graph, the system provides an improved and contextualized assessment of risk contagion across the institution's network.

Embodiments described herein model propagation of risk as a “contagious” information spreading process, specifically as a discrete diffusion process over a graph which is equipped with extra sheaf structure.

Embodiments described herein may provide a sheaf neural network system and method for modeling and analyzing risk contagion within a financial institution. The system constructs a cellular sheaf representation of the institution's network, wherein each entity (e.g., customer, account, subsidiary) is represented by a stalk, and the multi-dimensional relationships between entities are encoded in the restriction maps and coboundary operators of the sheaf.

Sheaf theory approaches involve a mathematical framework for encoding multi-dimensional and asymmetric relationships. Using a sheaf structure in the representation of the network effectively captures important relational information, including directional dependencies, signed relationships (e.g., debtor-creditor), and hierarchical structures (e.g., parent-subsidiary relationships).

While other approaches are limited to pairwise relationships between entities, embodiments described herein provide a useful computational mechanism for modelling multi-dimensional and asymmetric relationships by using an integration of sheaf theory and neural network architectures to model and analyze risk propagation in financial institutions. Embodiments described herein employ sheaf neural network architectures, such as sheaf convolutional neural networks or sheaf diffusion networks, to propagate risk signals along the various relational pathways encoded in the sheaf structure.

In some embodiments, domain knowledge and expert input may be incorporated such that the system may learn to identify and prioritize high-risk relational patterns that may lead to risk contagion. The outputs of the sheaf neural network may be used to generate risk scores, visualizations, and actionable insights for risk management and mitigation strategies.

Embodiments described herein provide a computing system configured for analysis and prediction of risk contagion for a graph network of nodes, where the computing system comprises: a computer hardware processor coupled to non-transitory computer memory and the non-transitory computer memory. The computer processor is configured to: construct a cellular sheaf representation of the graph network using a data processing module, the cellular sheaf representation comprising stalks, relational pathways, and a restriction maps, wherein the stalks are each initialized with a corresponding risk indicator, wherein the restriction maps encode multi-dimensional and asymmetric relationships between the stalks, wherein the relational pathways are encoded in the cellular sheaf representation; construct a sheaf neural network, comprising an input layer, at least one sheaf convolutional layer, at least one sheaf pooling layer, and an output layer; input the cellular sheaf representation into the sheaf neural network at the input layer; propagate risk signals along the relational pathways and through the stalks using the at least one sheaf convolutional layer, the propagating comprising applying an activation function to the risk indicators of the stalks and combining the risk indicators from related stalks based on the restriction maps; update the corresponding risk indicators of the stalks based on the restriction maps; aggregate and summarize the risk signals using the at least one sheaf pooling layer to transform the risk indicators by applying an operation on the updated risk indicators of the stalks; output the transformed risk indicators from the sheaf neural network; and generate risk scores based on the transformed risk indicators using the output layer. The non-transitory computer memory stores the cellular sheaf representation of the graph network.

In accordance with an aspect, embodiments described herein may further provide a visualization module for generating interactive visualizations of risk propagation pathways and potential contagion zones within the graph network.

In some embodiments, the computer processor may further train parameters of the sheaf neural network based on historical risk data and expert domain knowledge to optimize risk contagion analysis and prediction.

In some embodiments, constructing the cellular sheaf representation incorporates domain knowledge and expert input to identify relevant multi-dimensional and asymmetric relationships within the graph network.

In some embodiments, the computer processor may further identify high-risk relational patterns and potential contagion zones within the graph network based on the transformed risk indicators from the sheaf neural network.

In some embodiments, the sheaf neural network further comprises a sheaf diffusion layer that applies a sheaf Laplacian operator to the risk indicators before propagating the risk signals.

In some embodiments, the cellular sheaf representation models a network of a financial institution.

In some embodiments, each stalk represents an entity that is at least one of: customers, accounts, subsidiaries, business units, and geographical regions.

In some embodiments, the multi-dimensional and asymmetric relationships encoded in the restriction maps include at least one of: directional cash flows, debtor-creditor relationships, hierarchical structures, regulatory dependencies, and geographical proximities.

In an embodiment, an output of the sheaf neural network may be the maximum risk indicator across the plurality of stalks.

The foregoing has outlined rather broadly the features and technical advantages in order that the detailed description that follows may be better understood. Additional features and advantages will be described hereinafter. It should be appreciated by those skilled in the art that the conception and specific embodiment disclosed may be readily utilized as a basis for modifying or designing other structures. It should also be realized by those skilled in the art that such equivalent constructions do not depart from the spirit and scope of the embodiments described herein. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the embodiments described herein.

### BRIEF DESCRIPTION OF THE DRAWINGS

FIG. 1 is a block schematic diagram of an example of sheaf neural network effect propagation system.

FIG. 2 is a block diagram of a data structure of the sheaf neural network effect propagation system.

FIG. 3 is a block diagram illustrating physical components (e.g., hardware) of a computing device with which aspects of the disclosure may be practiced for a sheaf neural network effect propagation system.

FIG. 4 is a block diagram of a plurality of entities in sheaf neural network effect propagation system.

FIG. 5 is a method diagram showing example process of propagating risks using sheaf diffusion in a sheaf neural network effect propagation system.

### DETAILED DESCRIPTION

A methodological and systematic technical approach is proposed herein that provides a graph network data structure with cross dependencies and connections that utilizes sheaf neural networks to analyze and predict the propagation of risk within a financial institution. While not specifically limited to the banking sector and financial institutions, as a practical example, the approach may utilize the relational structure of sheaf neural networks to model the relationships and dependencies between various entities, such as customers, accounts, and subsidiaries within a financial institution. By incorporating and encoding the multi-dimensional and asymmetric relationships between the entities into the graph, the system provides an improved and contextualized assessment of risk contagion across the institution's network.

Embodiments described herein model propagation of risk as a “contagious” information spreading process, specifically as a discrete diffusion process over a graph which is equipped with extra sheaf structure. Embodiments described herein propose a sheaf neural network based approach and corresponding system and method for modeling and analyzing risk contagion, for example, but not limited to, within a financial institution. The system constructs a cellular sheaf representation of the institution's network, wherein each entity (e.g., customer, account, subsidiary) is represented by a stalk, and the multi-dimensional relationships between entities are encoded in the restriction maps and coboundary operators of the sheaf.

The proposed sheaf-based computing approaches involve a computational framework for encoding multi-dimensional and asymmetric relationships. Using a sheaf structure in the representation of the network effectively captures relational information, including directional dependencies, signed relationships (e.g., debtor-creditor), and hierarchical structures (e.g., parent-subsidiary relationships).

A sheaf neural network effect propagation system is provided herein. The system comprises a computer implemented algorithm that constructs a cellular sheaf structure, which may be a representation of the financial institutions' network with a plurality of entities, where each entity may be represented by a stalk. Each entity may be a customer, account, or subsidiary. The relationships between each entity may be encoded in restriction maps and coboundary operators of the cellular sheaf structure.

The sheaf neural network effect propagation system may be configured to capture the relational information or relational pathways, including directional dependencies, signed relationships (e.g., debtor-creditor), and hierarchical structures (e.g., parent-subsidiary relationships). The cellular sheaf structure may comprise sheaf neural network architectures, such as sheaf convolutional neural networks (ShCNN) or sheaf diffusion networks (SDN), such that risk signals may be propagated along various relational pathways encoded in the sheaf structure.

The sheaf neural network effect propagation system may be constructed based on mathematical concept of sheaf theory, wherein relationships and dependencies between the various entities within an organization may be propagated and analyzed concurrently. The sheaf neural network may be implemented by a specific input design and process steps, wherein the mathematical concept of sheaf theory may be applied in computer systems.

The sheaf neural network effect propagation system may be implemented to address risk-contagion propagation. This refers to a process by which financial distress or failure in one part of the financial system (such as a single bank or a specific financial instrument) spreads to other interconnected banks or markets, potentially leading to a broader financial crisis. This propagation typically occurs through direct and indirect linkages among financial entities and markets, where the distress of one entity may impact others through a variety of mechanisms. Such mechanisms may include counterparty risks, interconnected obligations, or market-confidence effects. Modeling these mechanisms reliably and concurrently may not be achievable through the conventional graph models, wherein every update is an average function of neighboring values. Repeating that averaging multiple times may force all nodes, representing the various entities, towards a same number. Therefore, conventional models may not reliably capture the risk-contagion propagation.

An example of contagion-risk propagation may be a large bank holding significant positions in derivatives linked to the creditworthiness of a company. If the company faces financial distress, the bank's derivative may be directly impacted. In turn, the bank's liquidity, solvency, and financial health of its counterparties may be affected. These affects are often multi-dimensional and asymmetrical. The risk value may propagate across the financial system, which may not be captured by conventional models.

The sheaf neural network effect propagation system may be implemented to address such risk propagation. This may be enabled by integrating sheaf theory with neural-network architectures to model and analyze risk propagation while accounting for the multi-dimensional and asymmetrical relationships between the entities within these organizations.

The sheaf neural network approach may begin with the sheaf representation layer, constructing a cellular sheaf representation of a network of various entities within an organization using a data processing module. The cellular sheaf representation includes nodes, stalks that represent risk indicators for each node, restriction maps that encode multi-dimensional and asymmetric relationships between the nodes, and relational pathways that are encoded in the cellular sheaf representation.

In the financial industry or banking sector, each stalk may represent an entity that is, for example, a customer, account, subsidiary, business unit, or geographical region. In the same industry, the multi-dimensional and asymmetric relationships encoded in the restriction maps may include, for example, directional cash flows, debtor-creditor relationships, hierarchical structures, regulatory dependencies, and geographical proximities.

To illustrate the sheaf neural network effect propagation system, consider a network of financial institutions with five nodes:

Entity A: Parent company
Entity B: Subsidiary of A
Entity C: Independent company
Entity D: Subsidiary of C
Entity E: Independent company

The nodes may be configured with the following relationships:

Hierarchical: A is the parent of B; C is the parent of D.
Credit-exposure: A has a loan to C; C has a loan to E.

Assume the following initial risk indicators (point-in-time probabilities of default (PD)):

rA = 0.2 (low risk)
rB = 0.3 (moderate risk)
rC = 0.4 (moderate risk)
rD = 0.15 (low risk)
rE = 0.5 (moderate-high risk)

Assuming that Entity D is an overseas subsidiary engaged in commodity trading. Entity C has issued a keep-well deed covering 80% of D's obligations, and C simultaneously carries a USD 75 million unsecured borrowing from A.

One day, Entity D incurs a USD 100 million regulatory fine for sanctions violations. Under group policy this constitutes an “internal default” event, so the point-in-time probability-of-default (PD) used by group risk jumps overnight from 0.15 to 0.60.

Distress at Entity D creates two asymmetric transmission channels: upwards to C, where the keep-well deed reverses the usual parent-to-subsidiary direction of risk transfer; sideways to A, where C's weakened credit quality increases its PD, of which only 60% is transmitted to lender A via the USD 75 million unsecured borrowing

The goal is to compute the post-shock PD vector and identify which entities require urgent risk mitigation actions, using a model that faithfully reflects direction, magnitude and asymmetry of the contagion pathways. In this network, risk clearly spreads directionally and unevenly. Standard graph models, with symmetric, unit-weighted edges, may not encode the keep-well's one-way obligation or the fractional transmission along the loan.

The sheaf neural network effect propagation system is designed to capture these directional, weighted and asymmetric pathways within its restriction maps and Laplacian, allowing us to predict how an initial shock propagates through the precise channels that a plain graph diffusion would otherwise misallocate.

The sheaf neural network effect propagation system may begin with constructing a cellular sheaf S, where each node represents an entity x∈{A,B,C,D,E}, and the stalks are initialized with the corresponding risk indicators rₓ (i.e. S=r at the beginning). The restriction maps of the sheaf may encode the hierarchical and credit exposure relationships between the entities, for example, ρ_{AB}: S_{A}→S_{B} may represent a relationship between entities A and B.

There may be another credit exposure relationship between nodes A, C, and E wherein A has a loan to C and C has a loan to E. These relationships may be encoded into the restriction maps of the sheafs such that ρ_{AB}: S_{A}→S_{B} (hierarchical relationship), ρ_{CD}: S_{C}→S_{D} (hierarchical relationship), ρ_{AC}: S_{A}→S_{C} (credit exposure relationship), and ρ_{CE}: S_{C}→S_{E} (credit exposure relationship).

$${ρ}_{AB} : {S}_{A} \to {S}_{B} ( hierarchical ) ,$$

$${ρ}_{CD} : {S}_{C} \to {S}_{D} ( hierarchical ) ,$$

$${ρ}_{AC} : {S}_{A} \to {S}_{C} ( credit - exposure ) ,$$

$${ρ}_{CE} : {S}_{C} \to {S}_{E} ( credit - exposure ) .$$

In this example, each stalk corresponding to the nodes A, B, C, D, and E may be initialized with risk indicators: r_{A}=0.2 (low risk), r_{B}=0.3 (moderate risk), r_{C}=0.4 (moderate risk), r_{D}=0.6 (high risk), and r_{E}=0.5 (moderate-high risk).

With a sheaf representation created, the organization may be modeled through the sheaf neural network with the entity relationships and risk factors represented by the corresponding nodes and stalks. A risk signal propagation may then be performed by the risk signal propagation layer.

This layer propagates the risk signals along the hierarchical and credit-exposure relationships encoded in the restriction maps. For example, the updated risk indicator for entity B may be computed as

$${r}^{′} B = σ ( w 1 rB + w 2 ρ AB ( rA ) ) ,$$

where σ is an activation function (e.g. sigmoid) and w1,w2 are learnable weights that determine the importance of the entity's own risk indicator and the risk propagated from its parent, respectively. Similar updates are defined for the other entities.

For simplicity, an example sheaf neural network architecture with one sheaf convolutional layer and one sheaf pooling layer may be considered for discussion of the approach below.

The input layer of the sheaf neural network may be configured to receive the cellular sheaf representation as input.

The sheaf convolutional layer of the sheaf neural network may propagate risk signals along the relationships encoded in the restriction maps. For example, using our previous example entities, the updated risk indicator r′B for entity B may be computed as:

$${r}_{B}^{′} = σ ( {w}_{1} {r}_{B} + {w}_{2} {ρ}_{AB} ( {r}_{A} ) ) \qquad ( 1 )$$

wherein σ is an activation function (e.g., sigmoid) and ω₁ and ω₂ are learnable weights that determine the importance of the entity's own risk indicator and the risk propagated from its parent, respectively. Similarly, the updated risk indicators for other entities may be computed based on their hierarchical and credit exposure relationships.

For diffusion, a sheaf Laplacian operator will need to be constructed. Using the previous example, a sheaf Laplacian matrix [symbol] may be constructed that captures the hierarchical and credit exposure relationships between the entities. Letting ρ_{xy} denote the restriction map from entity x to entity y, the sheaf Laplacian [symbol] may be defined as:

$$ℒ = I - {\sum }_{x , y} {ρ}_{xy} {ρ}_{xy}^{T} \qquad ( 2 )$$

Wherein I is the identity matrix and the sum is taken over all pairs of entities x and y with a non-zero restriction map ρ_{xy}. The sheaf Laplacian [symbol] encodes the multi-dimensional and asymmetric relationships present in the network, capturing how risk may propagate and diffuse along these relationships. The sheaf neural network architecture may be modified to incorporate the sheaf Laplacian for modelling the diffusion dynamics.

In some embodiments, the sheaf neural network effect propagation system may include a sheaf diffusion layer that applies the sheaf Laplacian operator to the risk indicators before propagating the risk signals. A sheaf diffusion layer may apply the sheaf Laplacian operator to the risk indicators before the sheaf convolutional layer and update them to create a diffused risk indicator:

$$\tilde{r} = ( I - αℒ ) r \qquad ( 3 )$$

wherein r=(r_{A}r_{B}r_{C}r_{D}r_{E}) T is the vector of initial risk indicators for all entities, a is a diffusion rate parameter (hyperparameter), and \tilde{r} is the diffused risk vector. The sheaf convolutional layer may then operate on the diffused risk vector \tilde{r}, propagating and updating the risk signals based on the diffusion dynamics encoded in the sheaf Laplacian. The operation (I-αL)r corresponds to applying the sheaf Laplacian [symbol] to the initial risk indicators r, with a diffusion rate controlled by a. This step informs on how the risk propagates and diffuses along the multi-dimensional and asymmetric relationships in the restriction maps encoded in the sheaf Laplacian. The resulting diffused risk vector f represents the updated risk indicators after the diffusion process.

In the sheaf neural network effect propagation system architecture, the sheaf convolution layer operates on the stalks Sₓ, which represents the risk indicators rₓ for each entity x. In general, the sheaf convolution is a learnable linear combination of the form:

$${S}_{x} = {\sum }_{y} {w}_{xy} {ρ}_{xy} ( {S}_{y} ) \qquad ( 4 )$$

wherein ρ_{xy} is the restriction map from the stalk Sₓ to the stalk S_{y}, and ω_{xy} is a learnable weight. This sheaf convolution combines the risk indicators r_{y} from multiple entities y that are related to x through the restriction maps ρ_{xy}. To incorporate the diffusion process into the sheaf convolution, an activation function σ (e.g., sigmoid or ReLU) may be applied to the diffused stalk S′ obtained from the sheaf Laplacian:

$${S}_{x}^{′} = σ ( ( I - αℒ ) {S}_{x} ) \qquad ( 5 )$$

The sheaf Laplacian [symbol] diffusion step models how risk propagates and diffuses along the network relationships and relational pathways.

The sheaf convolution layer, with some activation function applied to the diffused risk vectors, learns to combine the risk indicators from related entities while taking into account the diffusion dynamics.

The sheaf pooling layer of the neural network may aggregate and summarize the risk signals across the network, taking into account the multi-dimensional and asymmetric relationships. This may be done by applying an operation on the risk indicators to transform the risk indicators into a format or value that captures the network structure and relationships in a more meaningful way. For example, a simple pooling operation could be the maximum risk indicator across all entities:

$${r}_{max} = max ( {r}_{A}^{′} , {r}_{B}^{′} , {r}_{C}^{′} , {r}_{D}^{′} , {r}_{E}^{′} ) \qquad ( 6 )$$

The output layer of the neural network may output the result of the transformation performed by the sheaf pooling layer. The output of the neural network may be the updated risk indicators for individual entities (\tilde{r}ₓ), the maximum risk indicator (rₘₐₓ), or any other desired risk metric or visualization.

There are a number of reasons on why sheaf convolutions are more performant. First, the sheaf neural network effect propagation system enables directional and signed propagation. Using the example provided above, the keep-well edge transmits only 80% of D's PD jump to its parent C, while the credit edges pass just 60% of C's deterioration to lender A, a symmetric graph Laplacian may not encode those contractual limits and therefore overstates A's ultimate risk.

Secondly, the sheaf neural network effect propagation system provides asymmetric impact amplification. Node C receives two differently weighted inflows: 80% from D and 60% feedback through A. Its PD rises to 0.461 (vs. 0.428 in the plain model). Capturing such heterogeneity requires the non-square restriction maps that sheaf theory provides.

Lastly, sheaf neural network effect propagation system avoids indiscriminate over-smoothing. After ten steps, the simple graph diffusion drags every node toward a common mean (≈0.43), whereas the sheaf Laplacian preserves a steeper and economically justified separation: low-exposure nodes A, B remain safer, while C and E stay elevated in line with their true contagion paths.

In large-scale banking networks, where edges carry multi-dimensional cash-flow tensors and restriction maps are non-square, the performance gap widens even further, making the claimed Sheaf Convolution indispensable for fine-grained contagion forecasting.

The computing system may be configured to maintain, no non-transitory computer readable storage media, the graph data structure representations and the risk indicators. The risk indicators may be dynamically updated as the risk signals are propagated through the relational pathways and stalks of the network.

In accordance with an aspect, embodiments described herein may further provide a visualization module for generating interactive visualizations of risk propagation pathways and potential contagion zones within the graph network.

In some embodiments, the computer processor may further train parameters of the sheaf neural network based on historical risk data and expert domain knowledge to optimize risk contagion analysis and prediction. The approach may be practically implemented such that the system is configured for receiving data sets (e.g., over a message bus) representative of historical risk data and expert domain knowledge.

In some embodiments, constructing the cellular sheaf representation incorporates domain knowledge and expert input to identify relevant multi-dimensional and asymmetric relationships within the graph network. The approach may be practically implemented such that the system is configured for receiving data sets (e.g., over a message bus) representative of historical risk data and expert domain knowledge.

Embodiments described herein employ sheaf neural network architectures, such as sheaf convolutional neural networks or sheaf diffusion networks, to propagate risk signals along the various relational pathways encoded in the sheaf structure.

In some embodiments, domain knowledge and expert input may be incorporated such that the system may learn to identify and prioritize high-risk relational patterns that may lead to risk contagion. The outputs of the sheaf neural network may be used to generate risk scores, visualizations, and actionable insights for risk management and mitigation strategies.

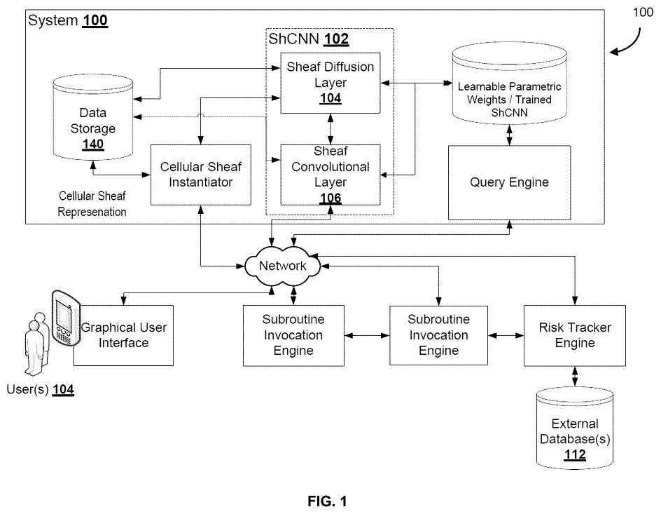

Referring to FIG. 1, the sheaf neural network effect propagation system 100 is configured to maintain in a data storage 140 a cellular sheaf representation data structure, which, during an instantiation process, may include an extracted representation of entities and interrelationships that may be obtained from tabular entity relationship information, for example, provided in the form of a comma separated values (CSV) file, or in structured relational database records. This information may be obtained either from storage, or accessed through a coupled network application programming interface (API) by requesting or receiving one or more data messages across the coupled network.

The instantiation step constructs the cellular sheaf representation data structure corresponding to the institution's network. To do so, the cellular sheaf instantiator may be configured to accept the following inputs: vertices, represented by a list of n identifiers (A, B, C, D, etc.); edges, represented by a list of n directed triples giving source vertex, target vertex and positive real-valued edge weight ((A, B, 1.0), (C, D, 1.0), (D, C, 0.8), etc.); initial risk vector, represented by a list of n numbers in the same order as the vertices, called risk; diffusion rate, represented by a positive real-valued constant scalar alpha; and step count, represented by a positive integer k.

Once instantiated, a sheaf convolutional neural network (ShCNN) architecture 102 is configured to model the risk propagation of the institution. The ShCNN architecture 102 may create an empty n*n matrix named coboundary. The coboundary may be populated for each edge (u, v, w), corresponding to a row index I. The ShCNN architecture may be configured to locate the column that corresponds to the source vertex u and store its negative weight −w in row i. The ShCNN architecture 102 may also be configured to locate the column that corresponds to the target vertex v and store its positive weight +w in row i.

The ShCNN architecture 102 may comprise a sheaf diffusion layer 104 and a sheaf convolutional layer 106, wherein a sheaf Laplacian operator for use in modelling diffusion dynamics in the sheaf diffusion layer 104 that is used in concert with a sheaf convolutional layer 106 that operates on a diffused vector, propagating and updating signals based on diffusion dynamics encoded in the sheaf Laplacian. This type of computing representation is conducted to provide a useful mechanism for computing that captures relational relationships, including directional dependencies, signed relationships, and hierarchical structures.

In practice, the sheaf Laplacian operator may be configured to compute the Sheaf Laplacian by multiplying the transpose of coboundary by itself (that is, coboundary.T*coboundary). The result of the above computation may be stored in an n*n matrix, labeled as Laplacian, stored within the sheaf convolutional layer 106.

The Laplacian matrix encodes the multi-dimensional and asymmetric relationships present in the network, capturing how risk may propagate and diffuse along these relationships. The ShCNN architecture 102 may incorporate the Laplacian for modeling the diffusion dynamics. In one example, the sheaf diffusion layer 104 applies the Laplacian operator to the risk indicators, represented by the initial risk vector risk, before the sheaf convolutional layer 106. The diffusion step may be configured as a single forward-Euler diffusion step. The sheaf convolutional layer 106 may then operate on the diffused vector risk, propagating and updating the risk signals based on the diffusion dynamics encoded in the sheaf Laplacian.

The diffusion step informs on how the risk propagates and diffuses along the multi-dimensional and asymmetric relationship encoded in the sheaf Laplacian. The resulting diffused risk vector may then be used to accurately represent risk indicators after the diffusion process.

The sheaf diffusion layer 104 may be configured to perform a diffusion loop on the risk vector risk, repeated over k times over the step count indicated by the system. The operation may be encoded as

$$risk = ( I - alpha * Laplacian ) * risk$$

wherein the final contents of risk is returned as the risk vector after k diffusion steps.

The output may be presented as an n-element floating-point vector that represents the updated risk vector for each vertex after the specified number of sheaf diffusion steps.

The sheaf neural network overcomes a challenge of the conventional graph model by addressing over-smoothing. In an ordinary graph model, every update is an averaging function of neighboring values. Repeating that averaging many times forces all nodes toward the same number, just like heat tend to stabilize towards one global value in a system. This is the “over-smoothing” problem.

A sheaf model adds two extra ingredients to each link between nodes. First, the sheaf model adds direction and strength: the system may be configured to mandate that only 30% of the value moves forward, or that it flows one way but not back. Secondly, the sheaf model enables location transformations. Before any changes are updated, each node may reshape its own information (via learnable weight matrices) and inject this fresh content into the mix.

Because flows are uneven and new, node-specific information is re-introduced at every step, the network never collapses to a single global average. Distinct patterns are preserved where the directions and weights say they should be, which solves the over-smoothing problem.

The ShCNN architecture 102 is configured to propagate signals across the pathways (from stalk to stalk) encoded in the sheaf structure. The ShCNN architectures have learnable parameters, such as weights, where the sheaf convolution is a learnable linear combination. The computing approach may be practically implemented as a physical computing system configured to construct a sheaf neural network, including an input layer, at least one sheaf convolutional layer, at least one sheaf pooling layer, and an output layer.

Once the ShCNN architectures are trained, they may be used for generating logic outputs based on an input for controlling downstream computing, such as automatically invoking subroutines based on identified triggers, generating table data outputs that may be used for report or visualization generation for rendering visual interface elements on a graphical user interface 108, among others.

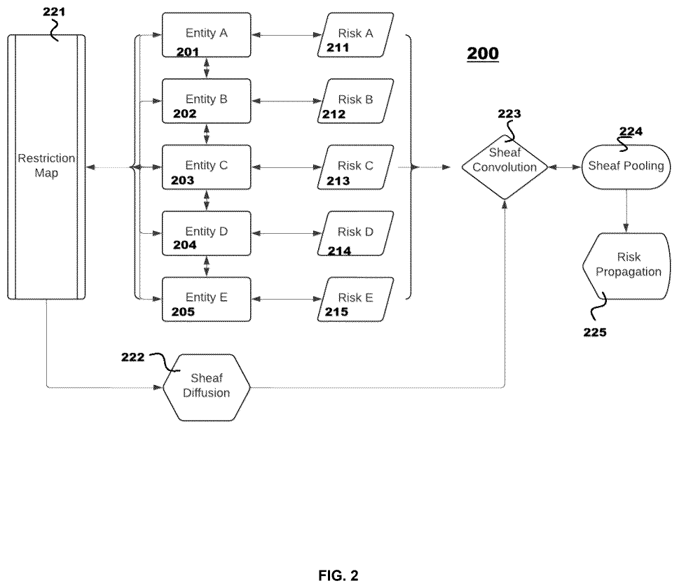

Referring to FIG. 2, a data structure of the sheaf neural network in an application of risk propagation is provided 200. In an example, a financial institution comprises at least five entities, as described above and shown as Entities A-E 201-205. Each entity may comprise an initial risk factor 211-215. The sheaf neural network may be configured to encode the entities with their corresponding risk factors as a sheaf representation. The risks may be propagated through a sheaf convolution layer 223, as described in FIG. 1.

Additionally, the entities 201-205 may have further relational data with each other. This relational data may include hierarchical, credit-exposure, etc. In the sheaf neural network, these relational data may be compiled and organized through at least one restriction map 221. The restriction maps 221 may be configured to represent the multi-dimensional and asymmetrical relationship between the nodes or entities.

The sheaf neural network effect propagation system may comprise a diffusion layer 222, wherein sheaf diffusion may be configured to encode the multi-dimensional and asymmetrical relationships present in the financial institution's network. In an example, a Laplacian operator may be applied to restriction maps 221 to model the diffusion dynamics among the entities 201-205. To avoid the over-smoothing problem often seen in graphical models, the diffusion layer 222 may comprise transformers configured for transforming the diffusion into a sheaf convolution.

The risk factors 211-215 may be modeled along with the sheaf diffusion output through a sheaf convolution layer 223. The sheaf convolution layer 223 may comprise at least a standard risk propagation operator, wherein a plurality of learnable weights may be applied to the risk factors to determine the importance of each entity's own risk factor and the risk propagated from its parent, respectively. This operation may be repeated until all risk factors for all entities are modeled through a standard risk propagation.

As mentioned above, the sheaf model keeps track of two factors between each entity node, in addition to the stalks that represent initial risk factors. The sheaf model may add direction and strength to relational data between each two entity nodes, such that impact of each event associated with entity node may be adjusted according to a variety of learnable train weights. Additionally, such impact may be regulated such that it only flows in one direction from one node to the other. Upon occurrence of each event, the plurality of learnable weights may be applied to the relational data, such that the risk propagation modeling may be adjusted in real time. The sheaf diffusion module may be configured to update with the any changes to relational data before any risk propagation analysis.

Subsequently or concurrently, sheaf neural network effect propagation system architecture may apply the sheaf Laplacian operator to the risk factors before the sheaf convolutional layer, thereby propagating and updating the risk factors based on the diffusion dynamics encoded in the sheaf Laplacian.

Finally, the sheaf pooling layer 224 may be configured to aggregate and summarize the risk factors 211-215 across the network, taking into account the multi-dimensional relationships 221 among the entities 201-205. In various implementations, more sophisticated pooling operations may be designed to capture the network structure and relationships in application specific manners 225.

As there may be a large number of multi-dimensional and asymmetric relationships between the nodes or entities, determining a risk score for each entity or node is non-trivial, and a machine learning based approach is proposed in embodiments herein that generates risk scores for entities in a dynamically updated system to minimize the computational cost of analyzing every relationship in a large network.

In some embodiments, the computer processor may further identify high-risk relational patterns and potential contagion zones within the graph network based on the transformed risk indicators from the sheaf neural network.

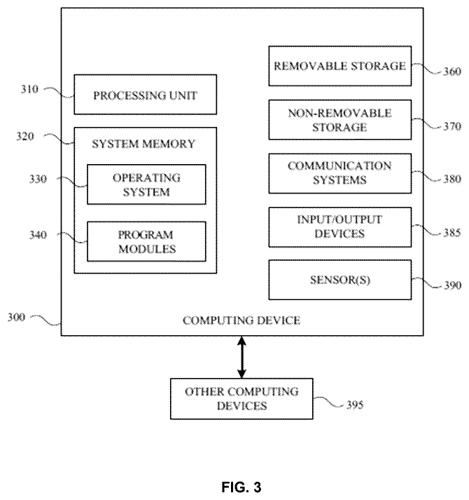

FIG. 3 is a block diagram illustrating physical components (e.g., hardware) of a computing device 300 with which aspects of the disclosure may be practiced. The computing device 300 may be integrated or otherwise associated with any of the various systems described above with respect to FIG. 1A and FIG. 1B. For example, the computing device 400 may be integrated or otherwise associated with a sheaf neural network system 100, comprising a sheaf neural convolution neural network 102 with a sheaf diffusion layer 04 and a sheaf convolution layer 106. The computing device 300 may be integrated with a cellular sheaf instantiator, a data storage 140, a query engine, and a database for learnable parametric weights for trained sheaf convolution neural network. The system 100 may be accessed by users through a graphical user interface connected to a network, wherein a plurality of subroutine invocation engines are configured to operate with a risk tracker engine connected to an external database 112.

In a basic configuration, the computing device 300 may include at least one processing unit 310 and a system memory 320. Depending on the configuration and type of computing device, the system memory 320 may comprise, but is not limited to, volatile storage (e.g., random access memory), non-volatile storage (e.g., read-only memory), flash memory, or any combination of such memories. The system memory 320 may include an operating system 330 and one or more program modules 340 or components suitable for performing the various operations described above. The operating system 330 may be suitable for controlling the operation of the computing device 300. The system memory 320 may include a database for learnable parametric weights and trained sheaf convolution neural network.

The computing device 300 may have additional features or functionality. For example, the computing device 300 may also include additional data storage devices (removable and/or non-removable) such as, for example, volatile memory, non-volatile memory, magnetic disks, optical disks, or tape. Such additional storage is illustrated in FIG. 3 by a removable storage device 360 and a non-removable storage device 370.

As stated above, a number of program modules 340 and data files may be stored in the system memory 320. While executing on the processing unit 310, the program modules 340 may perform the various processes including, but not limited to, the aspects, as described herein.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the computing device 300 on the single integrated circuit (chip). Examples of the disclosure may also be practiced using other technologies capable of performing logical operations such as, for example, AND, OR, and NOT, including but not limited to mechanical, optical, fluidic, and quantum technologies. In addition, examples of the disclosure may be practiced within a general-purpose computer or in any other circuits or systems.

The computing device 300 may also have one or more input/output device(s) 385. These include, but are not limited to, a keyboard, a trackpad, a mouse, a pen, a sound or voice input device, a touch, force and/or swipe input device, a display, speakers, a printer, etc. The aforementioned devices are examples and others may be used. The computing device 300 may include one or more communication systems 380 that allow or otherwise enable the computing device 300 to communicate with remote computing devices 395. Examples of suitable communication connections include, but are not limited to, radio frequency (RF) transmitter, receiver, and/or transceiver circuitry; universal serial bus (USB), parallel, and/or serial ports.

The computing device may include one or more sensors 390. The sensors may include location sensors, accelerometers, position sensors the like.

The term computer-readable media as used herein may include computer storage media. Computer storage media may include volatile and nonvolatile, removable and non-removable media implemented in any method or technology for storage of information, such as computer readable instructions, data structures, or program modules.

The system memory 320, the removable storage device 360, and the non-removable storage device 370 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which may be used to store information and which may be accessed by the computing device 300. Any such computer storage media may be part of the computing device 300. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein may comprise processors, electronics devices, hardware devices, electronics components, logical circuits, memories, software codes, firmware codes, etc., or combinations thereof. In addition, features discussed herein may be implemented via specialized processor circuitry, via executable instructions, and/or combinations thereof.

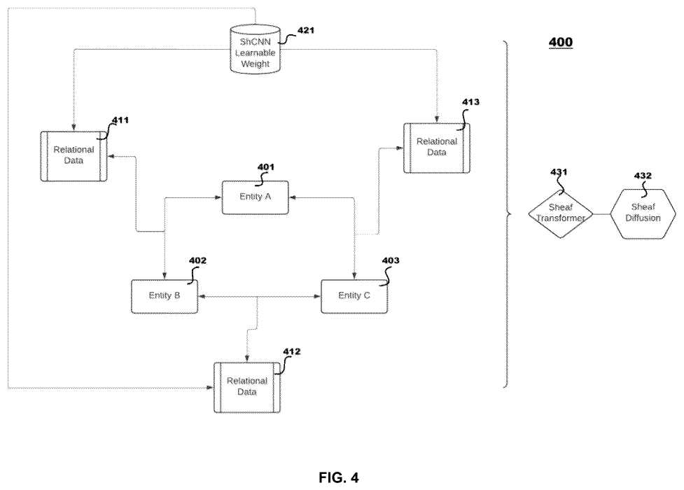

Referring to FIG. 4, operations leading to a sheaf diffusion operator is shown 400. In this example, a number of entities 401-403 are generated within the neural network, each containing a node and an edge, with a stalk for initial risk factors. There are relational data 411-412 connecting each of the entities, such that the multi-dimensional and asymmetrical relationship between entities 401-403 may be captured. As an example, the relational data 411 between Entity A 401 and Entity B 402 may comprise a direction (an event happening to A may impact B) and a strength (the event may lead to increase in debt-credit ratio of B). The sheaf neural network system may be configured to capture all relational data between each of the entities, which reflect the multi-dimensional and asymmetric relationship among the nodes.

In addition, a database for learnable weight 421 may be implemented. Learnable weights that determine the importance of the entity's own risk indicator and the risk propagated from its parent, respectively. The trainable weights may be entered into a number of trainable weight matrices, which may then be entered into a new representation of the relational data among the entities. This new formulation may allow users to diffuse the risk within a higher abstraction of the graph and avoid over-smoothing problems, resulting in more accurate diffusion dynamics. The weight matrices may be trained by setting a learning problem and making the sheaf convolution the update rule. Once the model reaches satisfactory predictive power, the trained weight matrices may be locked and reused in a single sheaf-convolution step to obtain an environment-aware risk estimate.

A sheaf transformer 431 may be implemented to model the multi-dimensional and asymmetric relational data among the entities. Compared to the pairwise graphic convolution network, the sheaf transformer accurately represent the entities effects and relationship to each other within an institution/network in a robust manner. Because flows are uneven and new, node-specific information is re-introduced at every step, the network never collapses to a single global average. Distinct patterns are preserved where the directions and weights say they should be, which solves the over-smoothing problem. The output of the sheaf transformer may be entered into the sheaf diffusion module 432, which then may be applied to sheaf convolution for the risk propagation process, as illustrated in FIG. 2.

Applying sheaf convolution to our example previously, the sheaf neural network risk propagation system yields a markedly different and more financially faithful risk-dispersion pattern than a plain graph-diffusion model. First, each of the entities are entered as nodes with edges and stalks into the instantiate layer, wherein an accurate representation is generated herein.

| Edge label | Relationship type | Sheaf weight w |
|---|---|---|
| A→B | Hierarchical (parent → subsidiary) | 1.0 |
| C →D | Hierarchical (parent → subsidiary) | 1.0 |
| D→C | Keep-well guarantee (subsidiary → | 0.8 |
| | parent) | |
| A→C | Credit exposure (loan) | 0.6 |
| C →E | Credit exposure (loan) | 0.6 |

Each node carries a scalar stalk equal to its point-in-time probability of default. Immediately after the regulatory fine,

$${r}^{( 0 )} = {( {r}_{A} , {r}_{B} , {r}_{C} , {r}_{D} , {r}_{E} )}^{T} = {( 0.2 , 0.3 , 0.4 , 0.6 , 0.5 )}^{T}$$

Next, the sheaf diffusion creates a coboundary matrix and performs 0-Laplacian operation thereon. In an example, The entities (A, B, C, D, E) are numbered as columns 1-5 and orient every edge from source (negative sign) to target (positive sign). With the five edges above, the weighted coboundary matrix is

$$\begin{matrix}- 1 & 1 & 0 & 0 & 0 \\ 0 & 0 & - 1 & 1 & 0 \\ 0 & 0 & 0.8 & - 0.8 & 0 \\ - 0.6 & 0 & 0.6 & 0 & 0 \\ 0 & 0 & - 0.6 & 0 & 0.6\end{matrix}$$

The 0-cochain sheaf Laplacian is computed using:

$$0 L ( 0 ) = δ TC 1 δ0$$

The result through the sheaf model may be shown as below, with comparison of results from play graphical models after ten step iterations.

| Node | Sheaf model | r(10 Plain graph model¹) | r(10 Δ (SNN − GCN)) |
|---|---|---|---|
| A | 0.2953 | 0.3396 | −0.044 |
| B | 0.2757 | 0.2975 | −0.022 |
| C | 0.4613 | 0.4276 | +0.034 |
| D | 0.4820 | 0.4851 | −0.003 |
| E | 0.4857 | 0.4503 | +0.035 |

As may be seen, the risk factors propagated through the sheaf model remains robust, while the plain graph model suffers from over-smoothing over time.

In various implementations, the sheaf model may be constructed using state of the art programming languages commonly used for neural networks. The sheaf neural network described herein may be constructed using high-level programming languages commonly used in machine learning and artificial intelligence, such as Python. Python is widely adopted due to its extensive ecosystem of machine learning libraries, including TensorFlow, PyTorch, and Keras, which provide robust tools for defining neural network architectures, preprocessing data, training models, and deploying trained models to production environments. Other languages such as Java, C++, or Julia may also be used, depending on system requirements and integration needs.

In an embodiment, a computer system accesses a digitally encoded dataset for a financial institution, comprising a plurality of entities with associated relational data and initial risk factors. A sheaf neural network architecture is instantiated in memory, with a sheaf representation of the entities as nodes with stalks corresponding to risk indicators. The sheaf neural network may comprise a restriction map layer to model the multi-dimensional and asymmetrical data between the nodes, wherein coboundary matrices may be created. The sheaf neural network may comprise a sheaf convolution module and a sheaf diffusion module to instantiate sheaf Laplacian and perform sheaf diffusion steps. The sheaf convolution layer may be compiled to enable a sheaf pooling layer, wherein risk propagation may be carried out. The sheaf neural network may generate an output comprising a vector that represents the updated risk vector for each entity represented in the vertex, after a specified number of shea diffusion steps.

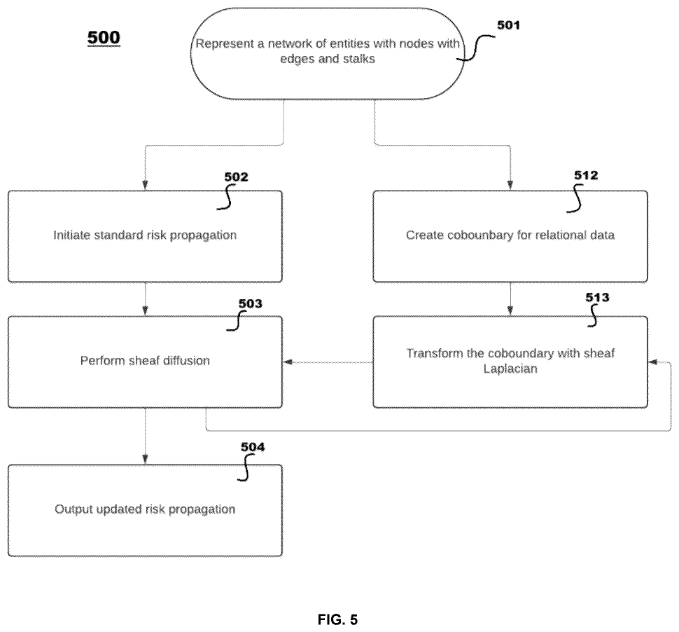

Referring to FIG. 5, a process for implementing a sheaf neural network effect propagation system is provided. The process begins by taking the information regarding a network with a plurality of entities and represent them accurately through a sheaf neural network 501. This may be accomplished by representing each entity as a node with edges (relational data to each other) and stalks (initial risk factor). Next, a standard risk propagation may be performed based on the initial risk factors 502. This risk propagation may be modified based on the results of the sheaf neural network. Concurrently, a coboundary matrix may be created to represent the relational data between each entities 512. The coboundary matrix may be designed to represent both direction and strength of relational effect of each entity towards each other. The relational data may be hierarchical or causal, forming a multi-dimensional and asymmetric relationship matrix.

The process follows by transforming the coboundary matrix with sheaf Lapacian 513. This may be accomplished by populating the coboundary matrix with edges from the nodes and locating the column within that correspond to source and targe vertex of each entity. The sheaf Laplacian may be computed by multiplying the transpose of the coboundary matrix by itself. This step may be repeated as new data enters into the system, representing the dynamic relationship matrix within the network.

The process then performs the sheaf diffusion on the standard risk propagation with the sheaf Lapacian transformed coboundary matrix 503. The sheaf diffusion may thus analyze the risk factors and how they may be impacted by the multidimensional and asymmetrical relationship among the network entities. Finally, the updated risk propagation is generated as an output for the sheaf risk propagation system 504.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods may consist of or consist essentially of—rather than comprise/include/have-any of the described steps, elements, and/or features. Thus, in any of the claims, the term “consisting of” or “consisting essentially of” may be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it may also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a processor, a digital signal processor (DSP), an ASIC), a field programmable gate array (FPGA) or other programmable logic device, discrete gate or transistor logic, discrete hardware components, or combinations thereof designed to perform the functions described herein. A processor may be a microprocessor, but in the alternative, the processor may be another form of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a computer, or a processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations may be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A computing system configured for analysis and prediction of risk contagion for network with a plurality of entities, comprising:
a cellular sheaf instantiator configured to construct a cellular sheaf representation of the network using a data processing module, the cellular sheaf representation comprising a plurality of nodes with a stalk and at least one edge, wherein each stalk represents a risk factor and each edge represents a relational data, wherein the plurality of relational data comprises a pathway and an impact, and are organized by at least one restriction map;
a sheaf convolutional neural network module comprising a sheaf diffusion layer and a sheaf convolutional layer, wherein the sheaf diffusion layer is with a transformer and the sheaf convolutional layer is configured to propagate a risk signal,
a database configured to organize a plurality of learnable weights,
wherein
the sheaf diffusion layer applies the plurality of learnable weights and performs a Laplacian transform operation to the plurality of relational data,
the sheaf convolutional layer propagates the risk signal at along the plurality of relational pathways, the propagating comprising applying an activation function and the impact to the risk factors of the plurality of nodes, and
the sheaf convolutional neural network module generates an updated risk signal.

2. The system of claim 1, comprising a sheaf pooling layer configured to aggregate the updated risk signal from the plurality of nodes across the network.

3. The system of claim 1, wherein the sheaf diffusion layer is configured to perform the Laplacian transform operation a predetermined number of times and the sheal convolutional layer is configured to propagate the risk signal at the predetermined number of times.

4. The system of claim 1, further comprising a visualization module for generating interactive visualizations of a plurality of risk propagation pathways and potential contagion zones within the graph network.

5. The system of claim 1, wherein the computer processor may further train parameters of the sheaf neural network based on historical risk data and expert domain knowledge to optimize risk contagion analysis and prediction.

6. The system of claim 1, wherein constructing the cellular sheaf representation incorporates domain knowledge and expert input to identify relevant multi-dimensional and asymmetric relationships within the graph network.

7. The system of claim 1, wherein the computer processor may further identify high-risk relational patterns and potential contagion zones within the graph network based on the transformed risk indicators from the sheaf neural network.

8. The system of claim 1, wherein the sheaf diffusion layer that applies a sheaf Laplacian operator to the risk indicators before propagating the risk signals.

9. A method for analysis and prediction of risk contagion for network with a plurality of entities, comprising:
constructing a cellular sheaf representation of the network using a data processing module, the cellular sheaf representation comprising a plurality of nodes with a stalk and at least one edge, wherein each stalk represents a risk factor, and each edge represents a relational data, wherein the plurality of relational data comprises a pathway and an impact, and are organized by at least one restriction map;
initiate a standard propagation on a risk signal,
applying a plurality of learnable weights to the plurality of relational data,
generating a coboundary matrix with the plurality of relational data,
performing a Laplacian transform operation to the coboundary matrix,
perform a sheaf diffusion based on the Laplacian transformed coboundary,
propagating a risk signal across the pathway, and
generating an updated risk signal.

10. The method of claim 9, comprising aggregating the updated risk signal from the plurality of nodes across the network.

11. The method of claim 9, comprising performing the Laplacian transform operation a predetermined number of times and the sheal convolutional layer is configured to propagate the risk signal at the predetermined number of times.

12. The method of claim 9, comprising generating interactive visualizations of a plurality of risk propagation pathways and potential contagion zones within the graph network.

13. The method of claim 9, comprising training parameters of the sheaf neural network based on historical risk data and expert domain knowledge to optimize risk contagion analysis and prediction.

14. The method of claim 9, comprising incorporating domain knowledge and expert input to identify relevant multi-dimensional and asymmetric relationships within the graph network.

15. The method of claim 9, comprising identifying high-risk relational patterns and potential contagion zones within the graph network based on the transformed risk indicators from the sheaf neural network.

16. The method of claim 9, wherein the sheaf Laplacian operator is applied to the risk indicators before propagating the risk signals.

17. A computer-implemented method for analyzing and predicting risk contagion for a graph network of a plurality of nodes, the method comprising:
constructing a cellular sheaf representation of the graph network using a data processing module, the cellular sheaf representation comprising a plurality of stalks, a plurality of relational pathways, and a plurality of restriction maps, wherein the each stalk represents a corresponding risk indicator for a node, wherein the plurality of restriction maps encode a plurality of multi-dimensional and asymmetric relationships between the plurality of nodes, wherein the plurality of relational pathways are encoded in the cellular sheaf representation;
constructing a sheaf neural network, comprising an input layer, at least one sheaf convolutional layer, at least one sheaf pooling layer, and an output layer;
inputting the cellular sheaf representation into the sheaf neural network at the input layer;
propagating a plurality of risk signals along the plurality of relational pathways and through the plurality of stalks using the at least one sheaf convolutional layer, the propagating comprising applying an activation function to the risk indicators of the plurality of nodes and combining the risk indicators from related nodes based on the plurality of restriction maps;
updating the corresponding risk indicators of the plurality of nodes based on the plurality of restriction maps;
aggregating and summarizing the plurality of risk signals using the at least one sheaf pooling layer to transform the risk indicators by applying an operation on the updated risk indicators of the plurality of nodes;
outputting the transformed risk indicators from the sheaf neural network; and
generating a plurality of risk scores based on the transformed risk indicators using the output layer.

18. The method of claim 17, comprising aggregating the updated risk signal from the plurality of nodes across the network.

19. The method of claim 17, comprising performing the Laplacian transform operation a predetermined number of times and the sheal convolutional layer is configured to propagate the risk signal at the predetermined number of times.

20. The method of claim 17, comprising generating interactive visualizations of a plurality of risk propagation pathways and potential contagion zones within the graph network.
